(19) United States
(12) Patent Application Publication
(10) Pub. No.: US 2009/0132339 A1
(43) Pub. Date: May 21, 2009

(54) Signature-Based Advertisement Scheduling

(75) Inventors: David H. Sloo, Menlo Park, CA (US); Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,606

(22) Filed: Nov. 21, 2007

(51) Int. Cl. G06Q 30/00

(52) U.S. Cl. 705/10; 705/14

(57) ABSTRACT

Signature-based advertisement scheduling techniques are described. In an implementation, a signature for each of a plurality of advertisements is computed that describes characteristics of the respective advertisements. The signatures are compared to determine similarities of the plurality of advertisements, one to another. The plurality of advertisements is then scheduled for output in conjunction with content based on the comparison.

### BACKGROUND

Advertising continues to be one of the major driving factors used to generate revenue by content providers and network operators. In traditional advertising models, advertisements were embedded in content, such as television programs, which were then broadcast “over the air” to consumers such that the consumers were able to consume the content. Thus, in this traditional model revenue collected from advertisers was used to support the provision of the content to users.

Traditional techniques that were used to schedule advertisements, however, were often crude and may even result in missed revenue opportunities under this model. For example, an advertiser may specify that a certain advertisement is to be aired a specified number of times during broadcast of a television program. In some instances, however, the advertisement may be broadcast in a manner that is inconsistent with desires of the advertiser, such as by displaying the advertisement back-to-back. In such an instance, the content provider and/or network operator may be forced to “make good” to the advertiser due to this inconsistency, e.g., by offering another advertising opportunity during another episode of the television program free of charge or for a reduced rate.

### SUMMARY

Signature-based advertisement scheduling techniques are described. In an implementation, a signature for each of a plurality of advertisements is computed that describes characteristics of the respective advertisements. The signatures are compared to determine similarities of the plurality of advertisements, one to another. The plurality of advertisements is then scheduled for output in conjunction with television content based on the comparison.

In another implementation, one or more computer-readable media include instructions that are executable to obtain user preferences that are based on monitored user interaction with one or more advertisements. One or more signatures of the one or more advertisements of the user preferences are compared with at least one signature of an advertisement that is to be output in conjunction with television content and output of the advertisement is scheduled based on the comparison.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ signature-based techniques to schedule advertisements.

FIG. 2 is an illustration of a system showing a network operator and clients of FIG. 1 in greater detail.

FIG. 3 is a flow diagram depicting a procedure in an exemplary implementation in which content is segmented and a signature is derived for the segments.

FIG. 4 is a flow diagram depicting a procedure in an exemplary implementation in which a user interface is provided by a network operator to schedule advertisements based on signatures generated for the advertisements.

FIG. 5 is a flow diagram depicting a procedure in an exemplary implementation in which user preferences are utilized in combination with signature-based techniques to schedule an advertisement.

### DETAILED DESCRIPTION

Overview

Users have access to an increasing range of content and techniques that may be used to consume that content, such as video-on-demand, digital video recorders, digital television systems that offer interactive programming, and so on. Traditional advertising models, however, often lagged these developments when it came to scheduling advertisements to be output in conjunction with the content, which may result in lost revenue opportunities.

Signature-based advertisement scheduling techniques are described. In an implementation, techniques are described to create a signature of an advertisement that describes characteristics of the advertisement. The signature may be formed in a variety of ways, such as through the use of vectors in which each vector represents a different characteristic.

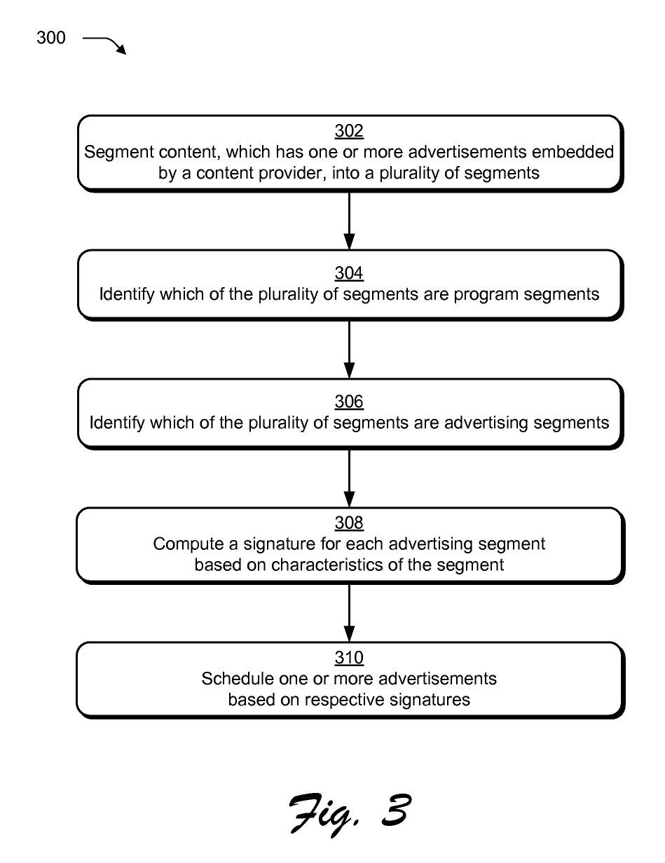

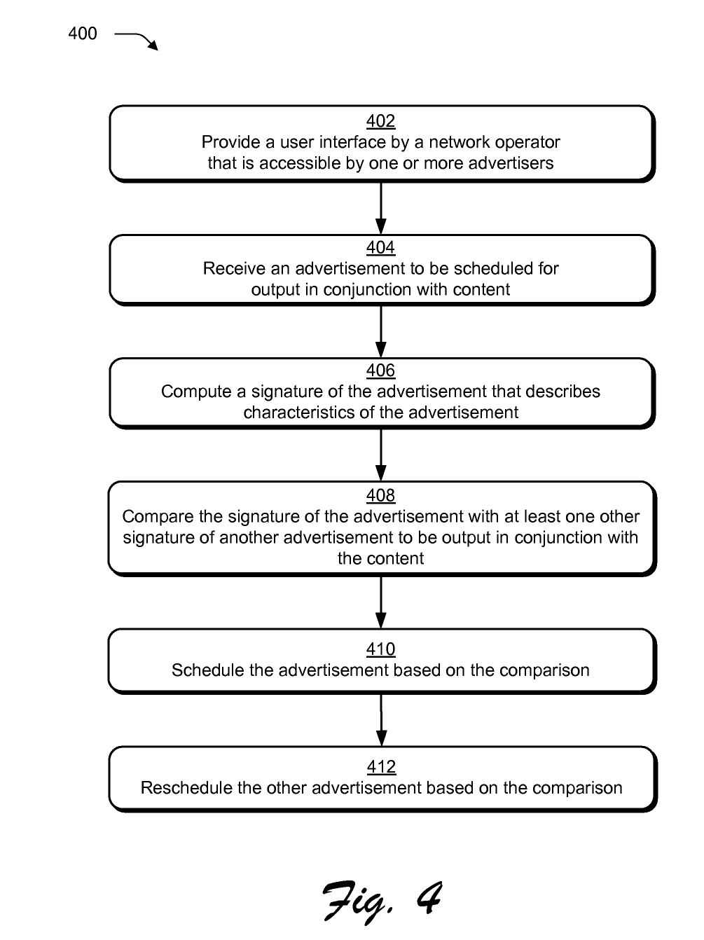

The signatures may then be used to compare the advertisements, one to another, for scheduling purposes. For example, the signatures may be used to determine whether particular advertisements are an identical match, such as to prevent back-to-back repeats of advertisements. The signatures may also be used to identify similar advertisements and schedule accordingly, such as to provide space between car ads such that one car advertisement does not directly follow another car advertisement. A variety of other instances are also contemplated, further discussion of which may be found in relation to FIGS. 3 and 4.

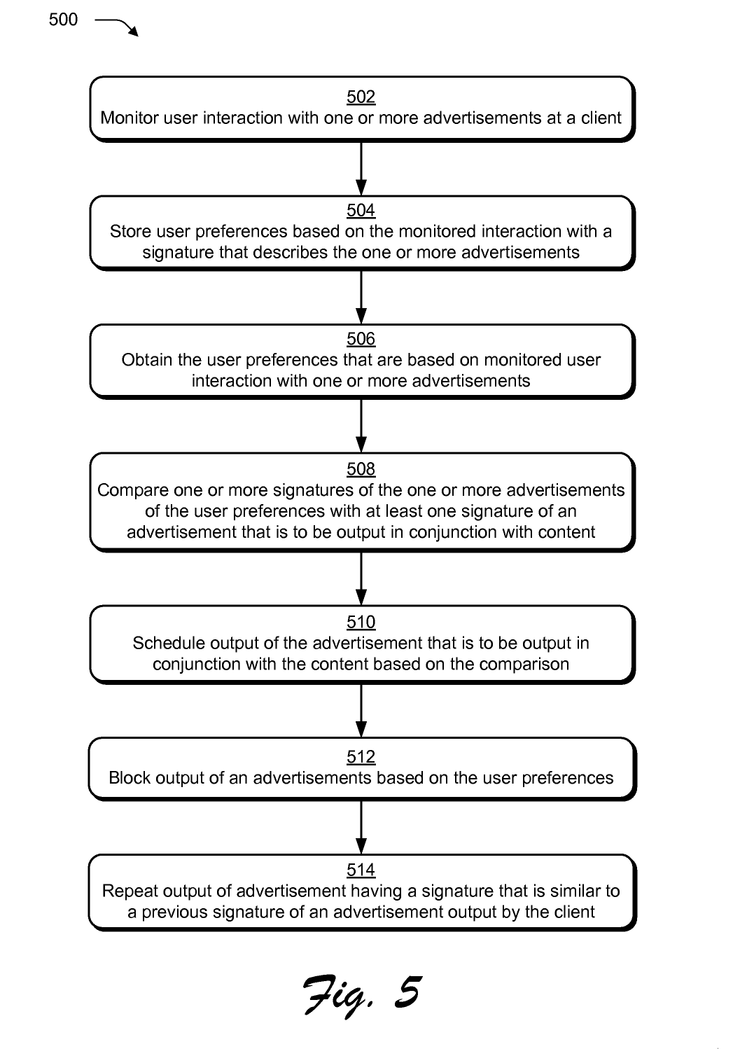

In another implementation, user interaction with advertisements is monitored at a client. For example, a user may interact with a digital video recorder (DVR) to “time shift” an output of a television program, such as to fast forward through advertisements. Signatures may be obtained which identify these advertisements, which may be stored as user preferences to schedule future advertisements, such as to block further output of those advertisements, cause additional output of other advertisements, and so on, further discussion of which may be found in relation to FIG. 5.

In the following discussion, an exemplary environment is first described that is operable to employ signature-based advertisement scheduling techniques. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

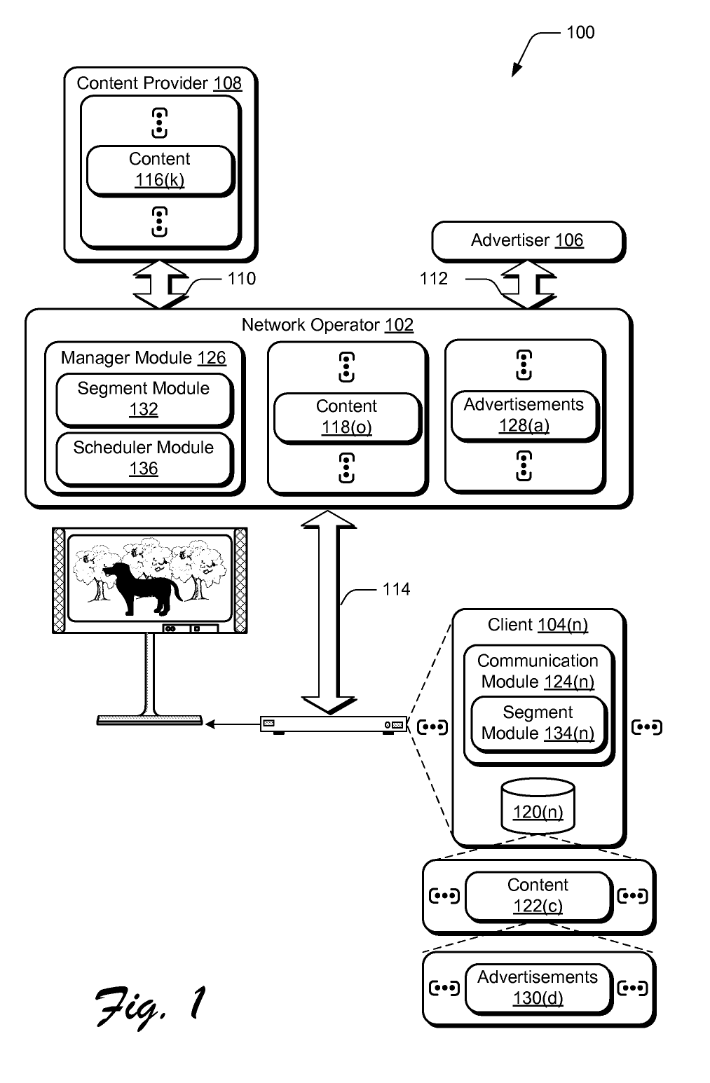

FIG. 1 is an illustration of an environment 100 in an exemplary implementation that is operable to employ signature-based techniques to schedule advertisements. The illustrated environment 100 includes a network operator 102 (e.g., a “head end”), one or more clients 104(n), an advertiser 106 and a content provider 108 that are communicatively coupled, one to another, via network connections 110, 112, 114. In the following discussion, the network operator 102, the client 104(n), the advertiser 106 and the content provider 108 may be representative of one or more entities, and therefore reference may be made to a single entity (e.g., the client 104(n)) or multiple entities (e.g., the clients 104(n), the plurality of clients 104(n), and so on). Additionally, although a plurality of network connections 110-114 are shown separately, the network connections 110-114 may be representative of network connections achieved using a single network or multiple networks. For example, network connection 114 may be representative of a broadcast network with back channel communication, an Internet Protocol (IP) network, and so on.

The client 104(n) may be configured in a variety of ways. For example, the client 104(n) may be configured as a computer that is capable of communicating over the network connection 114, such as a desktop computer, a mobile station, an entertainment appliance, a set-top box communicatively coupled to a display device as illustrated, a wireless phone, and so forth. For purposes of the following discussion, the client 104(n) may also relate to a person and/or entity that operate the client. In other words, client 104(n) may describe a logical client that includes a user, software and/or a machine (e.g., a client device).

The content provider 108 includes one or more items of content 116(k), where “k” can be any integer from 1 to “K”. The content 116(k) may include a variety of data, such as television content that may include television programming, video-on-demand (VOD) files, and so on. The content 116(k) is communicated over the network connection 110 to the network operator 102.

Content 116(k) communicated via the network connection 110 is received by the network operator 102 and may be stored as one or more items of content 118(o), where “n” can be any integer from “l” to “O”. The content 118(o) may be the same as or different from the content 116(k) received from the content provider 108. The content 118(o), for instance, may include additional data for broadcast to the client 104(n), such as electronic program guide (EPG) data.

The client 104(n), as previously stated, may be configured in a variety of ways to receive the content 118(o) over the network connection 114. The client 104(n) typically includes hardware and software to transport and decrypt content 118(o) received from the network operator 102 for rendering by the illustrated display device. Although a display device is shown, a variety of other output devices are also contemplated, such as speakers.

The client 104(n) may also include digital video recorder (DVR) functionality. For instance, the client 104(n) may include a storage device 120(n) to record content 118(o) as content 122(c) (where “c” can be any integer from one to “C”) received via the network connection 114 for output to and rendering by the display device. The storage device 120(n) may be configured in a variety of ways, such as a hard disk drive, a removable computer-readable medium (e.g., a writable digital video disc), and so on. Thus, content 122(c) that is stored in the storage device 120(n) of the client 104(n) may be copies of the content 118(o) that was streamed from the network operator 102. Additionally, content 122(c) may be obtained from a variety of other sources, such as from a computer-readable medium that is accessed by the client 104(n), and so on.

The client 104(n) includes a communication module 124(n) that is executable on the client 104(n) to control content playback on the client 104(n), such as through the use of one or more “command modes”. The command modes may provide non-linear playback of the content 122(c) (i.e., time shift the playback of the content 122(c)) such as pause, rewind, fast forward, slow motion playback, and the like.

The network operator 102 is illustrated as including a manager module 126. The manager module 126 is representative of functionality to configure content 118(o) for output (e.g., streaming) over the network connection 114 to the client 104(n). The manager module 126, for instance, may configure content 116(k) received from the content provider 108 to be suitable for transmission over the network connection 114, such as to “packetize” the content for distribution over the Internet, configuration for a particular broadcast channel, map the content 116(k) to particular channels, and so on.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(o) over a network connection to a multitude of clients, an example of which is illustrated as client 104(n). The client 104(n) may then store the content 118(o) in the storage device 120(n) as content 122(c), such as when the client 104(n) is configured to include digital video recorder (DVR) functionality.

The content 118(o) may also be representative of time-shifted content, such as video-on-demand (VOD) content that is streamed to the client 104(n) when requested, such as movies, sporting events, and so on. For example, the network operator 102 may execute the manager module 126 to provide a VOD system such that the content provider 108 supplies content 116(k) in the form of complete content files to the network operator 102. The network operator 102 may then store the content 116(k) as content 118(o). The client 104(n) may then request playback of desired content 118(o) by contacting the network operator 102 (e.g., a VOD server) and requesting a feed (e.g., stream) of the desired content.

In another example, the content 118(o) may further be representative of content (e.g., content 116(k)) that was recorded by the network operator 102 in response to a request from the client 104(n), in what may be referred to as a network DVR example. Like VOD, the recorded content 118(o) may then be streamed to the client 104(n) when requested. Interaction with the content 118(o) by the client 104(n) may be similar to interaction that may be performed when the content 122(c) is stored locally in the storage device 120(n).

To collect revenue using a traditional advertising model, the content provider 108 may embed advertisements in the content 116(k). Likewise, the network operator 102 may also embed advertisements 128(a) obtained from the advertiser 106 in the content 118(o) to also collect revenue using the traditional advertising model. For example, the content provider 108 may correspond to a “national” television broadcaster and therefore offer the content 116(k) and national advertising opportunities to advertisers, which are then embedded in the content 116(k). The network operator 102, on the other hand, may correspond to a “local” television broadcaster and offer the content 118(o) with the advertisements embedded by the content provider 108 as well as advertisements obtained from local advertisers to the client 104(n). Thus, the advertisements 130(d) which are included with the content 122(c) streamed to the client 104(n) may be provided from a variety of sources. Although national and local examples were described, a wide variety of other examples are also contemplated.

The manager module 126 is illustrated as including a segment module 132 which is representative of functionality to segment content (e.g., content 118(o)), into program segments and advertising segments. The segments, therefore, are distinct time segments of the content 118(o) that are differentiated by “what” is contained in the segments, in this case the program or advertising. Segmenting the content is not limited to the network operator 102 and may be performed by a variety of different entities, such as by a segment module 134(n) by the client 104(n) as illustrated in FIG. 1.

The segment module 132 may also be representative of techniques to uniquely identify the segments. For example, the segment module 132 may derive a signature for each of the segments based on characteristics in the segment, such as volume, images within the segments, use of color, identification of logos, frequency of frame output, volume level, associated metadata, and so on. Thus, in this example the signature helps identify “what” is contained in the respective segment. These signatures may be utilized in a variety of ways, such as to identify matching advertisements (e.g., the same advertisements being output at different times) as well as similar advertisements, such as advertisements in a similar genre, having a similar output type (e.g., action vs. spokesperson), and so on. It should be noted that implementation of the functionality represented by the segment module 132 is not limited to the network operator 102 and may be performed by a variety of entities, such as the client 104(n) as illustrated by segment module 134(n), a third-party web service, and so on.

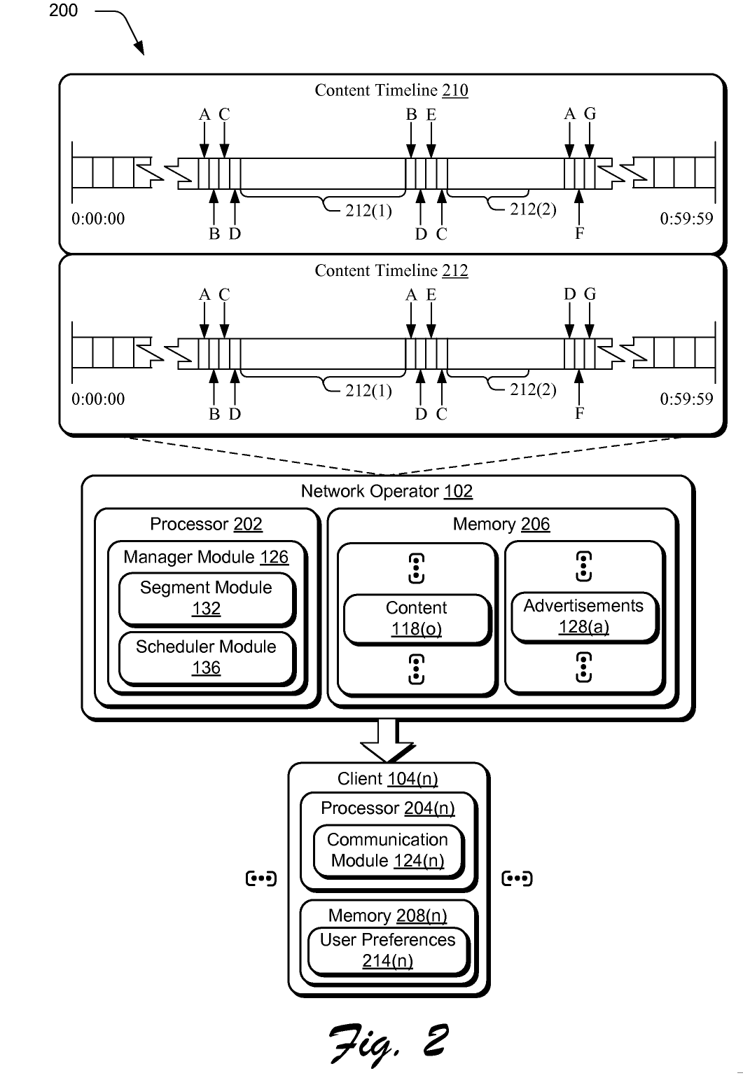

For example, the network operator 102 is also illustrated as including a scheduler module 136 which is representative of functionality to schedule advertisements. For instance, the scheduler module 136 may be configured as an executable module that schedules advertisements automatically and without user intervention based on signatures derived for the advertisements by the segment module 132. In another instance, the scheduler module 136 may output a user interface that provides for interaction with an advertiser to schedule the advertisements 128(a) for output with the content 118(o). This scheduling may be performed in a variety of ways, further discussion of which may be found in relation to FIG. 2.

FIG. 2 depicts a system 200 in an exemplary implementation showing the network operator 102 of FIG. 1 and the client 104(n) in greater detail. The network operator 102 and the client 104(n) are both illustrated as devices (e.g., the client 104(n) is illustrated as a client device) having respective processors 202, 204(n) and memory 206, 208(n). Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208(n) is shown, respectively, for the network operator 102 and the client 104(n), a wide variety of types and combinations of memory may be employed, such as random access memory (RAM), hard disk memory, removable medium memory, and other types of computer-readable media.

The network operator 102 is illustrated as executing the manager module 126 having the segment module 132 and the scheduler module 136 on the processor 202, which is storable in memory 206. As previously described, the segment module 132 is representative of functionality to segment content 118(o) into distinct time segments, an example of which is illustrated by a content timeline 210 in FIG. 2.

The content timeline 210 includes a plurality of distinct time segments to be output, which are illustrated as blocks, which may be segmented through execution of the segment module 132. In the illustrated content timeline 210, program segments 212(1), 212(2) that contain the program (e.g., do not contain advertisements) are noted through the use of brackets. Advertising segments are illustrated through the use of letters which identify particular advertisements. A first advertising block, for instance, is illustrated as including advertisements “A”, “B”, “C” and “D”. A second advertising block after program segment 212(1) is illustrated as including advertisements “B”, “D”, “E” and “C”. A third advertising block after program segment 212(2) is illustrated as including advertisements “A”, “F” and “G”.

Each of the advertisements as well as the program segments 212(1), 212(2) may be uniquely identified by the segment module 132 as previously described. For example, the segment module 132 may utilize a variety of characteristics that may help to uniquely identify the advertisements 128(a). Each of these characteristics may then be assigned to a dimension such that a multi-dimensional vector is derived that may act as a signature for the advertisements. Thus, the signature may directly identify the characteristics of a respective advertisement and/or program segment. The signatures may thus be utilized for a variety of purposes.

For example, the scheduler module 136 may schedule the advertisements 128(a) for inclusion in the content 118(o) based on the respective signatures generated by the segment module 132. For instance, metrics may be computed that indicate that consumer satisfaction and ad-effectiveness are heightened when an advertisements is shown a certain number of times and with a particular frequency, e.g., show advertisement “A” twice within a one-hour program at approximately ten minutes apart.

In this instance, the scheduler module 136 may use the signatures that uniquely identify the advertisements with the metrics to perform the scheduling. For example, the scheduler module 126 may reschedule advertisements of the content timeline 210 to form content timeline 212. During this rescheduling, advertisement “A” is moved from the third advertisement block in content timeline 210 (e.g., after program segment 212(2)) to the beginning of the second advertising block (e.g., after program segment 212(1)) to comply with the metrics.

In another example, the scheduler module 126 may take into account one or more user preferences 214(n). For instance, as previously described the communication module 124(n) may support time-shifting, such as to fast forward through advertisements during output of a television program in a DVR example. The user preferences 214(n) may be configured to reflect which advertisements and/or what are the characteristics of the advertisements that are watched or “skipped” through the use of signatures derived from a segment module 134(n) of FIG. 1. These user preferences may then be used by the scheduler module 136, such as to output similar advertisements, replace advertisements that are typically skipped with advertisements that are typically watched, and so on. Thus, the signatures may be used to schedule advertisements based on user preferences that may also incorporate (e.g., are indexed by) the signatures, further discussion of which may be found in relation to FIG. 5.

In a further example, the signatures may be used to identify characteristics of advertisements in a user interface such that the advertiser may select “when” and “where” to schedule an advertisement 128(a). The network operator 102, for instance, through execution of the scheduler module 136 may output a user interface having a content timeline. Advertising opportunities may be identified in the content timeline, with opportunities that have already been purchased represented through the use of signatures derived from the advertisements. Because the signatures may depict characteristics of the respective advertisements, the advertiser 106 may be readily informed as to the characteristics of other advertisements that are to be output in conjunction with the content 118(o) and plan accordingly. For instance, the advertiser 106 may schedule a desired advertisement a certain “distance” (e.g., amount of time) away from a substantially similar advertisement. A variety of other instances are also contemplated, further discussion of which may be found in relation to FIG. 4.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the signature-based advertisement scheduling techniques are platform-independent, meaning that the techniques may be implemented on a variety of commercial computing platforms having a variety of processors.

Exemplary Procedures

The following discussion describes signature-based advertisement scheduling techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 depicts a procedure 300 in an exemplary implementation in which content is segmented and a signature is derived for the segments. Content is segmented, which has one or more advertisements embedded by a content provider, into a plurality of segments (block 302). The content, for instance, may be received by a network operator 102 from a content provider 108. The content provider may correspond to a “national” broadcaster (e.g., CBS, ABC, NBC) that originated the content and includes advertisements in the content to collect revenue.

The content may be segmented in a variety of ways. For example, the different segments of the content may be segmented into thirty second distinct time periods. In another example, “breaks” between segments may be identified. A variety of other examples are also contemplated.

An identification is performed to determine which of the plurality of segments are program segments (block 304). An identification is also performed to determine which of the plurality of segments are advertising segments (block 306). For example, characteristics may be used to differentiate program segments from advertising segments. For instance, a higher volume level is generally observed for advertising segments as opposed to program segments. Scene changes, musical selection, dialog characteristics, identification of static images, and so on are further examples of characteristics that may be used to differentiate between programs and advertisements. Additionally, the identification may be performed such that advertisements are differentiated, one from another using similar techniques.

A signature is then computed for each advertising segment based on characteristics of the segment (block 308). As previously described, for instance, the signature may be computed as a multi-dimensional vector that describes characteristics of the advertising segment.

The one or more advertisements are then scheduled based on respective signatures (block 310). For example, the advertisements may be scheduled automatically and without user intervention through execution of the scheduler module 136 based on metrics which describe an optimal placement of the advertisements 128(a) within the content 118(o), e.g., two times, ten minutes apart within a thirty-minute television program, and so on. In another example, the scheduler module 136 may reschedule advertisements that are scheduled within a threshold amount of time that are too “similar” based on the signatures. For instance, the signatures may indicate that the advertisements share too many characteristics to be included in a same advertising block (e.g., the advertisements may match, have a similar “look and feel”, and so on) between program segments and consequently reschedule at least one of the advertisements in another advertising block. A variety of other examples are also contemplated, further discussion of which may be found in relation to the following figure.

FIG. 4 depicts a procedure 400 in an exemplary implementation in which a user interface is provided by a network operator to schedule advertisements based on signatures generated for the advertisements. A user interface is provided by a network operator that is accessible by one or more advertisers (block 402). The advertiser 106, for instance, may access a website of the network operator 102 using a web browser. A variety of other instances are also contemplated.

An advertisement is received to be scheduled for output in conjunction with content (block 404). Continuing with the previous instance, the network operator 102 may receive the advertisement 128(a) from the advertiser 106 via a web interface. In another instance, the network operator 102 may receive the advertisement 128 via a storage computer-readable medium, such as a digital video disk.

A signature is computed of the advertisement that describes characteristics of the advertisement (block 406). For example, the characteristics may be determined which are useful in differentiating one of the advertisements 128(a) from another advertisement 128(a), such as frequency of camera/scene changes, coloring, lighting, volume, audio dynamics (e.g., dialog), and so forth. Each of these characteristics may then be assigned to a vector/dimension, which is then used to compute a multidimensional vector that serves as a signature for the advertisement. A variety of other techniques are also contemplated that are based on characteristics of the underlying advertisement.

The signature of the advertisement is compared with at least one other signature of another advertisement to be output in conjunction with the content (block 408). The scheduler module 136, for instance, may compare the signature computed at block 406 with similarly computed signatures of other advertisements 128(a) to be output in conjunction with the content 118(o).

The advertisement may then be scheduled based on the comparison (block 410). Additionally, the other advertisement may be rescheduled based on the comparison (block 412). For example, the scheduling and the rescheduling may be based on similarities and/or differences of the signatures and consequently the characteristics of the respective advertisements. In this way, scheduling may be based on similarities of the characteristics even when the respective advertisements are non-matching, one to another. Thus, an optimal scheduled placement for the advertisement may be determined.

FIG. 5 depicts a procedure 500 in an exemplary implementation in which user preferences are utilized in combination with signature-based techniques to schedule an advertisement. User interaction with one or more advertisements at a client is monitored (block 502). For example, the user interaction may include use or nonuse of command modes to time shift an output of content, e.g., to fast forward through a particular television commercial while permitting output of another television commercial.

User preferences are stored based on the monitored interaction with a signature that describes the one or more advertisements (block 504). For example, the user interaction may be tracked for particular advertisements through use of a signature as previously described that describes characteristics of the signature. Thus, the signature may be used to uniquely identify the advertisements as well as the particular characteristics used to compute the signature. By associating the monitored interaction with the signatures, particular advertisements as well as characteristics may be tracked to more fully describe the actual preferences of the user.

The user preferences may then be obtained that are based on monitored user interaction with one or more advertisements (block 506), such as by the network operator 102, a communication module 124(n) from storage 120(n), and so on. One or more signatures of the one or more advertisements of the user preferences may then be compared with at least one signature of an advertisement that is to be output in conjunction with content (block 508). The other advertisement, for instance, may have already been received in a stream from the network operator 102 and output by the communication module 124(n). In another instance, the other advertisement may be scheduled for output by the network operator 102.

Output of the advertisement that is to be output in conjunction with the content is scheduled based on the comparison (block 510). This may be performed in a variety of ways. For example, the scheduling may include blocking output of the advertisement based on the user preferences (block 512), such as to replace the advertisement with another advertisement due to a previous “skipping of output” of the advertisement through time-shifting. In another example, output of the advertisement having a signature that is similar to a previous signature of an advertisement output by the client is repeated (block 514). For example, the communication module 124(n) may decide to repeat similar advertisements that were output by the client 104(n), such as to replace a blocked advertisement as described in relation to block 512 with an advertisement having desirable characteristics as indicated by the signature. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
computing a signature for each of a plurality of advertisements that describes characteristics of respective said advertisements;
comparing the signatures to determine similarities of the plurality of advertisements, one to another; and
scheduling the plurality of advertisements for output in conjunction with television content based on the comparison.

2. A method as described in claim 1, wherein each said signature uniquely identifies a respective said advertisement.

3. A method as described in claim 1, wherein the characteristics of at least two said advertisements match.

4. A method as described in claim 3, wherein the scheduling is performed such that the at least two said advertisements are not output back-to-back.

5. A method as described in claim 3, wherein the scheduling is performed such that the at least two said advertisements are not output within a same advertisement block of the content.

6. A method as described in claim 1, wherein the scheduling is performed based on one or more metrics that describe a desired frequency of output of a respective said advertisement.

7. A method as described in claim 1, wherein:
at least one said advertisement is provided by a content provider that originated the television content; and
one or more said advertisements are provided by a network operator that streams the content having the scheduled plurality of advertisements to a client.

8. A method as described in claim 1, wherein the computing, the comparing and the scheduling are performed via a user interface output by a network operator to an advertiser.

9. A method as described in claim 1, wherein:
each said signature is formed as a multidimensional vector; and
each said dimension corresponds to a respective said characteristic.

10. A method as described in claim 1, wherein the scheduling is further performed by taking into account one or more user preferences.

11. A method as described in claim 10, wherein the user preferences are described using signatures that describe the characteristics of advertisements with which a user has interacted.

12. One or more computer-readable media comprising instructions that are executable to:
obtain user preferences that are based on monitored user interaction with one or more advertisements;
compare one or more signatures of the one or more advertisements of the user preferences with at least one signature of an advertisement that is to be output in conjunction with television content; and
schedule output of the advertisement that is to be output in conjunction with the television content based on the comparison.

13. One or more computer-readable media as described in claim 12, wherein each said signature:
uniquely identifies a respective said advertisement; and
describes characteristics of the respective said advertisement through use of a multidimensional vector, each said dimension corresponding to a respective said characteristic.

14. One or more computer-readable media as described in claim 12, wherein the user preferences describe particular said advertisements of the one or more advertisements that were time-shifted.

15. One or more computer-readable media as described in claim 12, wherein the user preferences describe particular said advertisements of the one or more advertisements that were output.

16. One or more computer readable media comprising instructions that are executable to:
receive an advertisement to be scheduled for output in conjunction with television content;
compute a signature of the advertisement to be scheduled for output in conjunction with the content using a multidimensional vector, each vector dimension corresponding to a characteristic of the advertisement; and
schedule the advertisement to be output based on a comparison of the signature to a plurality of other said signatures computed from other advertisements to be output in conjunction with the television content.

17. One or more computer readable media as described in claim 16, wherein the advertisement is scheduled at least in part based on another advertisement that is also to be output in conjunction with the television content and has the characteristics that match the characteristics of the advertisement.

18. One or more computer readable media as described in claim 16, wherein the advertisement is scheduled at least in part based on one or more user preferences involving at least one said other advertisement that has one or more said characteristics that do not match the advertisement to be scheduled.

19. One or more computer readable media as described in claim 16, wherein at least one said other advertisement has at least one similar but non-matching characteristic.

20. One or more computer readable media as described in claim 16, wherein the advertisement is scheduled through output of a user interface.
